(19) United States
(12) Patent Application Publication
(10) Pub. No.: US 2006/0169114 A1
(43) Pub. Date: Aug. 3, 2006

(54) Apparatus for trimming metal strip

(76) Inventor: John E. Wilson, Goshen, KY (US)

Correspondence Address: CALFEE HALTER & GRISWOLD, LLP, 800 SUPERIOR AVENUE, SUITE 1400, CLEVELAND, OH, 44114, US

(21) Appl. No.: 11/391,983

(22) Filed: Mar. 29, 2006

Related U.S. Application Data
(62) Division of application No. 09/815,962, filed on Mar. 23, 2001.

(51) Int. Cl. B26D 7/06

(52) U.S. Cl. 83/24

(57) ABSTRACT

A slitter for webs, such as sheet aluminum or other metals, has a simple and effective method and apparatus for controlling the movement of a strip of metallic trim into a scrap reclamation system. One or more air nozzles direct a stream of air between the knife roll and the trim strip in the area where the trim strip leaves the knife roll. This presses the trim strip away from the knife roll, and reduces the risk that trim will adhere to the knife roll and cause problems.

This invention relates to a method and apparatus for trimming sheet material, typically handled in the form of large coils. More particularly, it relates to the method and apparatus for trimming light gauge aluminum in which the trim or strap is directed positively and effectively into a scrap reclamation system.

### BACKGROUND

Light gauge aluminum coils typically undergo a process of “trimming” or “center cutting”. As the web is uncoiled, it passes over a knife roll. The roll is used in conjunction with stationary knives to cut thin strips of aluminum from the main sheet. Thus, this operation creates continuous strips of aluminum scrap or trim as the coil is processed. These trim strips are generally between ⅛ and 2 inches wide and can be generated at speeds of up to a few thousand feet/minute. This trim is picked up at the machine by use of “trim tubes”. As the trim is cut from the web, a vacuum generated by large fans that are part of the overall “trim system” draws it into the trim tube. The trim is carried by the trim system to a central scrap staging area where it awaits further processing.

As the processing speed is increased, or if the trim is especially wide, there is a tendency for the trim to be drawn to the surface of the knife roll. Frequently, at some point during processing of a coil, the trim makes contact with and adheres to the knife roll. When this happens, the trim no longer travels into the trim tube but instead, wraps around the roll, quickly causing a web break, shutdown and sometimes further problems.

Various mechanical devices, such as plate type guides constructed of thin material such as plastic or sheet metal, have been used to try and deflect the trim strip from the roll and guide it into the trim tube. These have largely been unsuccessful due to the difficulty in getting them positioned properly and because the trim strip tends to drag and catch on the surface of the plate. One or more attempts have also been made to guide the trim or scrap into the trim tube with a jet of air blowing toward the mouth of the trim tube, i.e., in the direction of movement of the scrap strip. This method may be effective for thicker and stiffer strip, which has a tendency to escape the vacuum of the trim system and be ejected outward towards the rewind side of the trim tube. But it is of absolutely no use in preventing light gauge trim (less than 0.001″) from being drawn to the surface of the knife roll.

U.S. Pat. No. 4,484,500 to Reba et al. discloses apparatus to form a spirally wound paper roll product formed from convolutions cut from a parent web. The system includes first and second slitters and trim removal means, positioned close to the second slitter, with Coanda nozzles that induce a fluid flow into a scrap collection unit. The patent indicates that this flow is a combination of the air flow from the nozzles themselves and ambient air entrained therein. The air from the nozzle and entrained ambient air apply a pulling force to both the trim strip and the parent web. The combined flow draws the trim into a trim or scrap collector (column 5, lines 9-18, lines 33-36). In a conventional fan based trim system, this entire function is replaced by fans themselves.

In the system proposed by Reba et al, the Coanda nozzles must be positioned very close to the moving web and trim strip. As is evident from the drawings, the web used in conjunction with the Reba nozzle must be positioned between the knife roll and the nozzle. This is opposite of several conventional applications. These two requirements make the nozzle very difficult, if not impossible, to use with the configuration of many existing machines. There is nothing in the patent which suggests that a comparable system, or any other system employing one or more air jets, would be suitable for trimming sheet aluminum or other metals. The rollers (150 and 152) which are critical to the Reba system are highly undesirable for aluminum trimming. The rollers change the path of the strip and would most likely cause several other problems including marking of the strip, strip wrinkles and strip breaks due to the localized force on the strip at the rollers.

### SUMMARY OF THE INVENTION

This invention provides a simple and effective method and apparatus for controlling the movement of a strip of metallic trim into a scrap reclamation system. It utilizes an air nozzle that does not resemble Reba's, either structurally or in method of operation. The orifice of Reba's nozzle is a thin slit—(Coanda nozzles typically have slits on the order of 0.002″ wide). It produces a high velocity stream of turbulent air which tends to conform to a surface downstream of the nozzle, as long as that surface has no sharp corners or other such discontinuities. In the Reba nozzle the Coanda effect causes the air to flow around the curved edge of the nozzle into the scrap tube. As mentioned above, the air from the Coanda nozzle induces ambient air to flow in the same direction, i.e., into the scrap tube. This tends to create a slightly reduced air pressure between the knife roll and the trim strip, in the area where the trim strip leaves the roll.

The air nozzles of this invention operate in a different manner. Instead of causing a thin high velocity jet of turbulent air to wrap around the end of the nozzle, one or more nozzles direct a stream of air between the knife roll and the trim strip in the area where the trim strip leaves the knife roll. Some embodiments of this invention do take advantage of the same “wall attachment” effect relied on by Reba et al to guide the air around the knife roll to the area where the trim strip separates from the roll. However, instead of causing an air stream to wrap around the end of the nozzle and flow in the scrap tube, as in Reba's system, the nozzle of this invention directs an air stream against the surface of the knife roll and in a direction opposite to the travel of the knife roll and trim strip. The stream of air follows the contour of the roll and provides a wedge between the strip and the roll. This positively forces the trim strip away from the knife roll, rather than relying on whatever tension may be induced in the strip in systems such as Reba's. The nozzles of this invention can be a relatively large distance from the web. The position of the nozzle is not overly critical. Nozzle placement is on the same side of the strip as the knife roll.

As noted above, Reba's Coanda nozzles must be positioned very close to the moving web and trim strip, between the knife roll and the nozzle. This is opposite to several conventional applications, and make this nozzle very difficult, if not impossible, to use with many existing machines. The systems of this invention avoid this problem. Moreover, they do not require the rollers which are critical to the Reba system. These would be highly undesirable for aluminum trimming because they would change the path of the strip and would most likely cause several other problems, including marking of the strip, strip wrinkles and strip breaks.

Other features and advantages of this system will be apparent from the following detailed description.

### DRAWINGS

FIG. 1 in a schematic side elevation view illustrating the movement of sheet metal through a slitter embodying this invention.

FIG. 2 is an enlarged evaluation view, from the same viewpoint on FIG. 1, illustrating the movement of the fixed web into a slitting station, and the movement of product webs and trim strips from the station.

FIG. 3 is an end elevation view of a product web and a trim strip leaving the trimming station.

FIG. 4 is a detailed elevation view taken along lines 4-4 in FIG. 2, of the trim tube and air knife nozzle.

FIG. 5 is a top plan view of the trim tube and air knife nozzle.

FIG. 6 is an enlarged side view of the tip of the nozzle shown in FIGS. 2, 4 and 5.

FIG. 7 is an end view of the tip shown in FIG. 6, showing the orifice in the nozzle.

### DETAILED DESCRIPTION

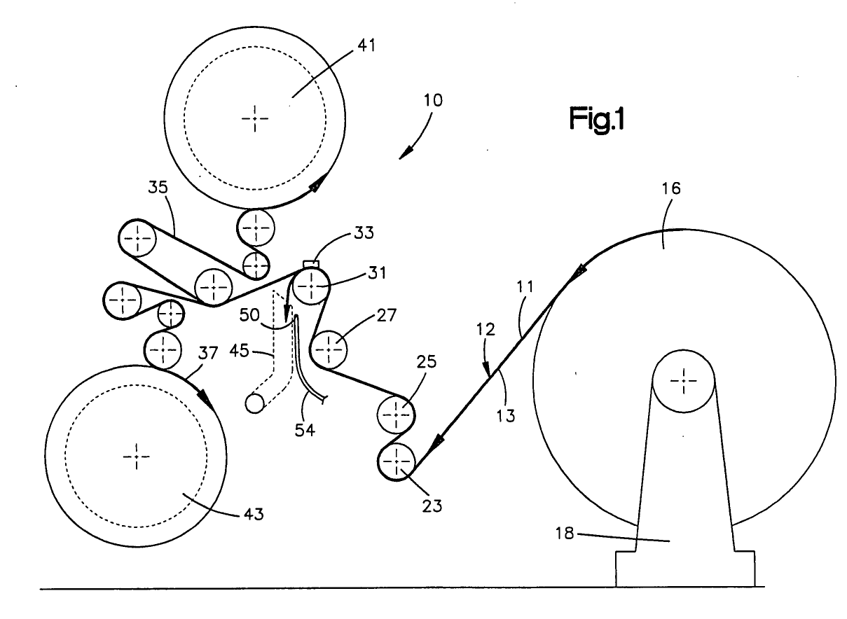

FIG. 1 is a partial side elevation view of a slitter, generally referred to as 10, embodying this invention. A thin, doubled web 12 of aluminum, comprising two individual or separate sheets 11, 13, is fed to slitter 10 from a supply coil 16 on a stand 18. The doubled web 12 is typically about 0.0005 inches to about 0.002 inches thick and about 24 to 52 inches wide. The individual sheets 11, 13 that make up the doubled web are typically between about 0.00025 and about 0.001 inches thick. The incoming web passes around idler rollers 23, 25, 27 to a slitting station. In the slitting station the web passes over and around knife roll 31. Two or more slitters 33 (fixed razor blades are illustrated, but rotary blades could also be used) are biased against the web as it passes around the knife roll and make the desired cuts in the web.

The knife roll 31, as is typical of rolls used in the slitting of light metal sheets or webs, has a series of alternating square grooves and lands, each approximately 1/32″ wide. The lands support the web, and each slitter blade projects part way into one of the grooves, which helps the blade cut the web cleanly.

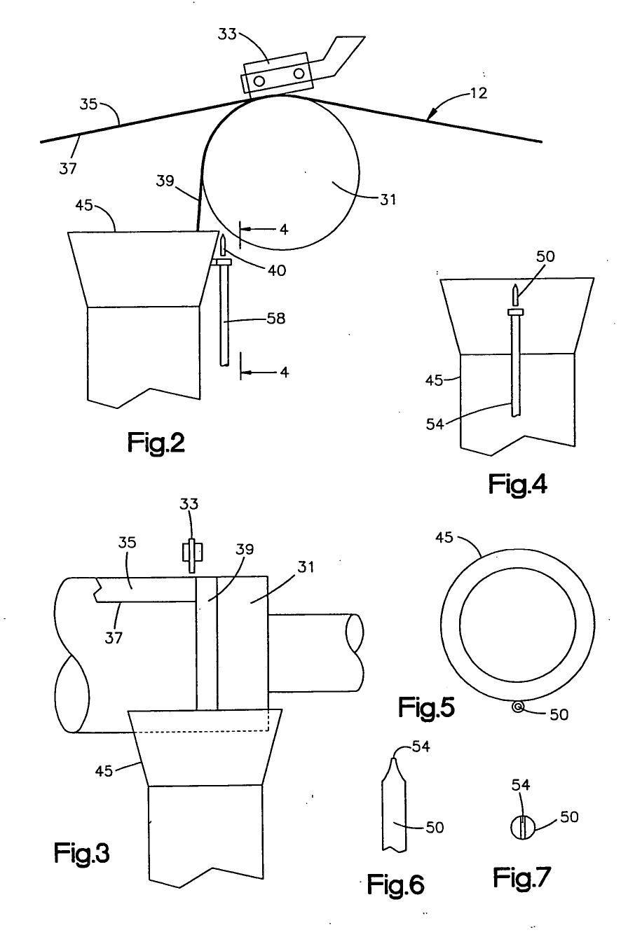

FIGS. 2 and 3 illustrate one of a pair of slitters in the illustrated system: the slitter on the near end (FIG. 2) or right hand end (FIG. 3) of knife roll 31. A complimentary slitter (not shown) is positioned at the other and of roll 31. Each removes a trim strip from one edge of the web. The trim strips are typically about ⅛ inch to about 2½ inches wide; depending on the desired final width and cracks or other defects at the edge of the web. If narrower product sheets are desired, an additional pair of slitters may be positioned in the center of knife roll 31. The center slitters are typically positioned about ⅛ inch to about 1 inch apart, generating a trim strip of the same width.

In the illustrated slitter the feed web 12 is slit in into two product webs 35, 37, which correspond respectively to the upper sheet 11 and lower sheet 13 of doubled web 12, and two doubled trim strips. The doubled trim strip 39 from the near or right end of web 12 is shown in FIGS. 2 and 3. Product web 35 is wound on upper rewind coil 41, and product web 37 is wound on lower rewind coil 43, using conventional rewind systems. Upper rewind coil 41 and lower rewind coil 43 pull the product webs 35, 37 and feed web 12 through the slitter 10, typically at speeds of about 1,000 to about 2,500 feet per minute.

The trim strip 39 is collected by a trim tube 45 (utilizing vacuum generated by remote fans, not shown) and carried by the remote fans to a central scrap staging area for further processing. The trim strip from the other end of knife roll 31 and any trim strip or strips that may be trimmed from the center of the web are collected by similar trim tubes (not shown) and also carried to the central scrap staging area. A vacuum generated within the tube by large fans (not shown) helps to draw the trim strip 39 into the trim tube 45. Alternatively or additionally, nozzles may inject air into the trim tube 45, near its mouth, and induce a flow of entrained air into the trim tube. The drawing or pulling force of the ambient air entrained by the remote fan system, by inductive nozzles, or a combination of one or more fans and nozzles is frequently insufficient to prevent the trim strip from being pulled to the surface of the knife roll. The design of the Reba nozzle has this same deficiency.

In the illustrated system, however, an air knife nozzle 50 mounted at the upper edge of trim tube 45, between the trim strip 39 and knife roll, directs a stream of air against knife roll a short distance from the area where the trim strip 39 leaves the knife roll 31. The nozzle emits a stream of fluid that flows generally outward from the nozzle, with minimal Coanda effects around the side of the nozzle, flows around the side of the knife roll (where it is subject to wall attachment or Coanda effects) and presses against the lower side of the strip, i.e. the side adjacent to the knife roll, in the area where the trim strip separates from the roll The stream generates a positive pressure against the trim strip 39, which positively forces the trim strip away from the knife roll.

The illustrated nozzle 50 may be constructed simply by flattening the end of a copper tube to produce the illustrated narrow, elongated orifice 52. The illustrated nozzle terminates in an end or discharge face 54 that is substantially perpendicular to the bore of the nozzle. The relatively sharp edge or discontinuity between discharge face 54 and the bore of the nozzle reduces any Coanda effects around the side of the nozzle.

The size and shape of the orifice, and the orientation of the nozzle may be adjusted to suit differing materials, sheet, equipment and/or processes. Various other nozzles, commercial or otherwise, that will provide a positive stream of air against the trim strip in the area where it leaves the knife roller may also be used. In some instances the nozzle may be angled so that the stream of air is aimed directly into the area where the trim strip leaves the roll, but superior performance is generally obtained by directing the air stream against the knife roll, as illustrated, which tends to smooth our turbulence and other discontinuities in the air stream.

Air is supplied to nozzle 50 through a tube 54, and the flow rate is adjusted by a flow regulating needle valve (not shown) mounted with other controls for the slitter. The flow may be adjusted manually to the rate which provides the most satisfactory operation. In typical installations, nozzle pressures of 15 to 20 psi and flow rates of 30 to 90 SCFH have been satisfactory. These conditions generate an air stream that provides a positive force against trim strip 39, which helps to insure that the trim strip will not remain attached to the knife roll and disrupt the slitting operation.

As may be seen from the foregoing description, this invention provides a system for positively, effectively and economically separating trim scrap from the surface of the knife roll of a slitter. The nozzles of this invention provide a wedge of air that generates a positive force on the trim strip in the area where the strip separates from the knife roll. This positively urges or moves the trim strip away from the knife roll and towards the scrap reclamation trim tubes, which substantially eliminates or reduces the risk that the trim will adhere to the knife roll and cause time consuming and expensive production problems. Moreover, unlike the Reba et al system, it does not require critical location of the nozzles in areas that are unsuitable for current slitters.

Of course, those skilled in the art will understand that many modifications may be made in this system within the scope of this invention, which is defined by the following claims.

1. Apparatus for trimming scrap from a moving metal strip, comprising:
a knife roll adapted to support said metal strip as it moves around said roll;
a blade biased against said metal strip as the metal strip moves around the roll, said blade being adapted to trim a strip of scrap from said metal strip; and
a nozzle, positioned on the same side of the strip of scrap as the knife roll, adapted to direct a stream of air against the surface of the knife roll in the area where said strip leaves said roll and in a direction generally opposite to the travel of the knife roll and the strip for causing the air stream to press against the side of the strip adjacent to the knife roll and force said strip away from said roll.

2. Apparatus according to claim 1 wherein said metal strip comprises sheet metal or foil

3. Apparatus according to claim 2 wherein said metal strip comprises aluminum.

4. (canceled)

5. Apparatus according to claim 4 wherein said nozzle comprises a bore having a discontinuity at a discharge from said nozzle that reduces any Coanda effects around the surface of said nozzle.

6. Apparatus according to claim 5 wherein said bore terminates at a discharge face that is substantially perpendicular to said bore.

7. A slitter for a metal strip, the slitter comprising:
a knife roll adapted to support said metal strip as it moves around said roll;
a blade biased against said metal strip as the metal strip moves around the roll, said blade being adapted to trim a strip of scrap from said metal strip sheet or foil;
a scrap processing system, comprising:
a trim tube with a mouth adapted to receive the scrap from said knife roll, said trim tube being connected to and adapted to convey the scrap to a chamber; and
a nozzle, on a same side of the scrap as the knife roll, adapted to emit a stream of fluid that flows generally outward from said nozzle and in a direction generally opposite to the direction the knife roll travels, with minimal Coanda effects around the side of said nozzle, the fluid pressing against the surface of the knife roll and a side of said scrap adjacent to said knife roll, for facilitating separation of the scrap from the knife roll in an area where said scrap separates from said roll.

8. A slitter according to claim 7 further comprising a fan adapted to reduce pressure within said trim tube.

9. A slitter according to claim 7 further comprising a nozzle adapted to inject fluid into said trim tube and induce a flow of entrained air into said trim tube.

10.-18. (canceled)
